(19) United States
(12) Patent Application Publication
(10) Pub. No.: US 2007/0048020 A1
(43) Pub. Date: Mar. 1, 2007

(54) Color order fulfilment method

(75) Inventor: Scott Meixner Silence, Fairport, NY (US)

Correspondence Address: PEPPER HAMILTON LLP, ONE MELLON CENTER, 50TH FLOOR, 500 GRANT STREET, PITTSBURGH, PA, 15219, US

(73) Assignee: Xerox Corporation

(21) Appl. No.: 11/210,091

(22) Filed: Aug. 23, 2005

(51) Int. Cl. G03G 15/01

(52) U.S. Cl. 399/223

(57) ABSTRACT

The disclosure is directed to a method of offering colors within a color system for use in xerography. The method includes providing at least a first toner of a first color. The first toner is selected from a set of pre-qualified colors. A customer request for a second toner is received, the second color being different than the first color. The second color is then qualified and then the second toner of the qualified second color is provided.

### BACKGROUND

1. Technical Field

The disclosure generally relates to methods of offering a range of colors for use in dry xerography. More particularly, the disclosure relates to methods for offering colors such as PANTONE® colors to customers for use in dry ink processing.

2. Description of Related Art

Customer selectable colors are typically utilized to provide instant identification and authenticity to a document. As such, the customer is usually highly concerned that the color meets particular color specifications. For example, the red color associated with Xerox Corporation's digital stylized “X” is a customer selectable color having a particular shade, hue and color value. Likewise, the particular shade of orange associated with Syracuse University is another example of a customer selectable color. A more specialized example of customer selectable color output can be found in the field of “custom color”, which specifically refers to registered proprietary colors, such as those used, for example, in corporate logos, authorized letterhead and official seals. The yellow associated with Kodak® brand products, and the brown associated with Hershey® brand products are examples of custom colors which are required to meet exacting color standards in a highlight color or spot color printing application.

The various colors typically utilized for standard highlighting processes generally do not precisely match customer selectable colors. Moreover, customer selectable colors typically cannot be accurately generated via halftone process color methods because the production of solid image areas of a particular color using halftone image processing techniques typically yields non-uniformity of the color in the image area.

Further, lines and text produced by halftone process color are very sensitive to misregistration of the multiple color images such that blurring, color variances, and other image quality defects may result. As a result of the deficiencies noted above, customer selectable color production in electrostatographic printing systems is typically carried out by providing a singular premixed developing material composition made up of a mixture of multiple color toner particles blended in preselected concentrations for producing the desired customer selectable color output. This method of mixing multiple color toners to produce a particular color developing material is analogous to processes used to produce customer selectable color paints and inks. This is different in offset printing, which is a printing technique whereby ink is spread on a metal plate with etched images, then transferred to an intermediary surface such as a rubber blanket, and finally applied to paper by pressing the paper against the intermediary surface. In offset printing, for example, a customer selectable color output image is produced by printing a solid image pattern with a premixed customer selectable color printing ink as opposed to printing a plurality of halftone image patterns with various primary colors or compliments thereof.

This concept has generally been utilized in electrostatographic printing technology, as disclosed, for example, in commonly assigned U.S. Pat. No. 5,557,393, wherein an electrostatic latent image is developed by a dry powder developing material including two or more compatible toner compositions which have been mixed together to produce a customer selectable color output. Customer selectable color printing materials including paints, printing inks and developing materials can be manufactured by determining precise amounts of constituent basic color components making up a given customer selectable color material, providing precisely measured amounts of each constituent basic color component, and thoroughly mixing these color components.

This process is commonly facilitated by reference to a color guide or swatch book containing hundreds or even thousands of swatches illustrating different colors, wherein each color swatch is associated with a specific formulation of colorants. Probably the most popular of these color guides is published by Pantone, Inc. of Carlstadt, N.J. The PANTONE® color system or formula guides express colors using a certified matching system and provides the precise formulation necessary to produce a specific customer selectable color by physically intermixing predetermined concentrations of up to four colors from a set of up to 18 principal or basic colors. There are many colors available using the PANTONE® system or other color formula guides of this nature that cannot be produced via typical halftone process color methods or even from mixing selected amounts of cyan, magenta, yellow and/or black inks or developer materials.

In the typical operational environment, an electrostatographic printing system may be used to print various customer selectable color documents. Electrostatographic printing systems typically develop an electrostatic latent image using solid toner particles either in powder form or suspended in a liquid carrier. An example of a device that utilizes dry xerography is a digital production press offered by Xerox Corporation called an iGen3® color printing system, including the iGen3® 110 Digital Production Press. The iGen3® xerographic development system operates by depositing toner onto a photoreceptor in the absence of a liquid solvent. The toner may be conveyed to the photoreceptor by a combination of electrostatic and mechanical forces. The toner may be deposited on the photoreceptor by these forces and excess toner may be removed from the photoreceptor by the same forces. Electrostatic forces in the deposition and removal of the toner from the photoreceptor play an important role in dry xerography because electrostatic forces are present and generally predominate in such systems. The electrostatic charge is put onto the toner particle by means of mechanical agitation with a carrier particle. The amount and spatial distribution of the charge put on the toner depends on the chemistry of the surfaces of both the carrier and the toner particles. Also, selective development, which relates to the difference in the amount of electrostatic charge on a toner particle or its spatial distribution on the toner particle, may and commonly does affect the probability that a particular toner particle will be deposited on and also remains in the intended image area of a photoreceptor after that latent image has been fully developed. Additionally, the amount of electrostatic charge on a toner particle or its spatial distribution on the toner particle may affect the probability that a toner particle will be transferred from the photoreceptor to the paper. Thus, dry xerography systems are more complex than liquid systems including liquid ink offset or liquid xerographic processes.

Traditional liquid ink offset systems do not use electrostatic forces to ink or de-ink the plates used in the printing and therefore do not have the electrostatic development selectivity constraints as described above present in dry xerography. While liquid xerographic processes may rely on electrostatic charges on pigmented resin particles dispersed in a solvent, the charge is not deposited mechanically but by means of the addition of a charge director into the liquid which uniformly charges the pigmented resin particles that has a charge control agent in the particle, independent of the chemical composition of the pigment. Further, the presence of a high dielectric charge director layer around each particle electrostatically screens the particles in the solution from each other decreasing any interaction between the particles which could lead to non-uniformities in the amount or spatial distribution of charge. Thus, the electrostatic selectivity in liquid systems is greatly reduced relative to dry xerographic development systems, and therefore color stability due to differential development is minimized.

Thus, due to at least the mechanical and electrical force differences between the liquid systems and the dry ink systems, an initial offering of, for example, a wide variety of colors in dry xerography is difficult. As a practical matter offering a high quality range of colors that accounts for the electrostatic forces and selective development in dry xerography is not easily done. To test and develop all the colors in a color system, for example the PANTONE® system, time, money and resources are needed. Additionally, testing and development may be done for colors that may never be purchased, thereby yielding an ineffective use of resources.

Accordingly, there is a need for a cost-effective and time-efficient method or system for customers to order a color from a variety of available colors for use in dry ink processing.

### SUMMARY

An embodiment includes a method of offering colors within a color system for use in xerography. The method includes providing at least a first toner of a first color, where the first toner may be selected from a set of pre-qualified colors. A customer request may then be received for a second toner of a second color, the second color being different than the first color. The second color may then be qualified and the second toner of the qualified second color may then be provided.

The qualified second color may be provided in a toner housing of a printing device. The first toner and second toner may be dry toners. The second color may be provided based on consumer preference data. The qualifying second color may include performing color stability and color accuracy tests on the second toner. The qualified second color may have a color stability of up to about 3ΔE. The method may further include the step of adding the qualified second color to the set of pre-qualified colors.

Another embodiment is directed to a method of fulfilling an order for toners for use in a color production printing device. The method includes offering a first list of toner colors, receiving a request for a toner of a desired color not included on the first list of toner colors, performing color stability and color accuracy tests on the toner of the desired color, and providing the toner of the desired color.

The toners may be dry toners. The toner of the desired color may be located in a toner housing of the color production printing device and may be located in a separate housing from the first list of toner colors. The toner colors from the first list of toner colors may be a subset of colors in a color system. The colors on the first list of toner colors may have a color stability of up to about 3ΔE. The method may also include the step of adding the toner of the desired color to the first list of toner colors.

In yet another embodiment is disclosed a printing device for use in xerography. The printing device includes at least one toner housing for receiving pre-qualified color toners and a compartment for receiving qualified toners. The qualified toners may be customer requested colors. The qualified toners may have a color stability of up to about 3ΔE. The compartment may be at least one of a toner housing, a portion of the toner housing or a separate unit. The compartment may be located separate from the at least one toner housing. The compartment may be located within the at least one housing.

### BRIEF DESCRIPTION OF THE DRAWINGS

FIG. 1 is a flow chart illustrating an embodiment of the disclosure.

### DETAILED DESCRIPTION

In embodiments, the words “device” or “printing device” are used interchangeably and are not to be limited therein, but are to include all devices capable of utilizing dry xerography including printers, printing presses, digital production presses, copiers, fax machines, and the like.

While the discussion herein is in terms of the PANTONE® color system, it is not limited to the PANTONE® color system but includes variations of the PANTONE® custom color system as well as other types or variations of color systems including a variety of colors. The words “color” and color values include colors and color values in the PANTONE® color system, a CMYK system using a cyan-magenta-yellow-black model in which all colors are described as a mixture of these four process colors, an RGB system including systems using red-green-blue (RGB) hexadecimals or decimal values, as well as other types or variations of color palettes or systems.

The word “qualifying” used in the disclosure is used generally to describe a process whereby, for example, a PANTONE® color may be tested and is considered to achieve a certain performance level acceptable for industry use.

In an embodiment, a printing device toner color selection system offers customers a range of colors for use in dry xerography printing processes including offset printing. For example, a popular color matching system used by the printing industry to print colors is the PANTONE® matching color system. Most applications that support color printing allow specification of colors by indicating the PANTONE® name or number. This allows an individual to obtain a desired color when a file is printed, even though the color may not look right when displayed on a monitor, for example.

To offer a PANTONE® color in dry xerography, the toner or ink of the Pantone® color is made, for example, to a high degree of accuracy and a high degree of stability. For example, there are over 1,000 standard PANTONE® colors used in the graphic arts/printing industry and about half of them can be produced by a typical four color printing process, with the remainder of the color being outside of the color gamut of a typical four-color process. To achieve or obtain the PANTONE® colors outside these four color combinations, toner mixtures need to be developed that represent all PANTONE® colors that can achieve from about 85% to about 100% of the known PANTONE® color space. Additionally, the difference in the color of developed images, or ΔE, preferably may be from about 0.1 to about 3 CIELAB units, more preferably from about 0.1 to about 2 CIELAB units, compared to the color of a target image. CIELAB is the industry standard system used to represent a three dimensional color space, with the coordinate system given by the axes of L, a, b (or equivalently L, C, h). This system provides a three-dimensional representation for the perception of color stimuli, with the difference between any two points in that color space given by ΔE, which is defined as the magnitude of the three dimensional vector between the points (adjusted for the sensitivity of the human eye in the particular region of color space in which the points lie. If for example, two points in space, representing two stimuli, are coincident then the color difference between the two stimuli, and the ΔE value, is zero. As the distance in space between two points increases the color difference between the stimuli that the two points represented increases accordingly.

An example of a method of providing colors from a color system includes having a small set of primary types of toner particles, for example, between 9 and 14 primary toner particles differing in at least the pigments that are in the toners. The small set of primary types of toner particles may then be mixed together as dry powders to produce a desired color. For example, a developer of a printing device may have 2 or more chemically distinct types of toner in or available to it. This arrangement allows for the minimization of chemical differences between toner particles with different pigments in them or at least the particle surfaces that are involved in the charging. However, some differences may remain that may result in electrostatic differences between toner particles with different pigments, and therefore some degree of selective development may remain.

Accordingly, by blending any one or more of the primary set of toners in a specified formulation, virtually all of the color systems, such as PANTONE®, colors may be matched. Suitable methods for blending and mixing the toners are described in U.S. Pat. No. 6,002,893 to Caruthers, Jr. et al., entitled “High And Low Pigment Loadings For Custom Colors”; U.S. Pat. No. 6,575,096 to Caruthers, entitled “Computer Controlled Mixing Of Customer-Selected Color Inks For Printing Machines”; and U.S. Pat. No. 5,557,393 to Goodman, et al., entitled “Process And Apparatus For Achieving Customer Selectable Colors In An Electrostatographic Imaging System”, the disclosures of all of which are incorporated in their entirety by reference herein.

The blended color mixtures may be tested until the desired color properties or attributes are achieved. Testing may be performed to assure a desired quality level is achieved. Tests may include varying system noises such as cycling the machine up and down. Variables such as color shift or stability and color accuracy may also be monitored. Color accuracy refers to how close a blended toner is to some reference target. Color accuracy may also refer to how close to some reference target the image on the page is under some standard set of system setpoint. The system setpoints may include toner age, developed mass per unit area (DMA), pigment mass per unit area (PMA), image equity parameters such as color shift or image gloss, and the like. Color stability refers to the movement in the color in an image over the system noises. This may be measured by monitoring variables such as toner age, DMA, developer age, environmental conditions such as temperature and relative humidity (RH), specific toner concentration (TC) and triboelectric value in the development housing, fusing parameters and the like. Acceptable performance levels for color stability and accuracy may be developed based on the application, device, use and the like. In an embodiment, the color accuracy may be up to about 3ΔE, preferably 2ΔE, which may be maintained over all possible noises during operation of the device. After satisfying the desire performance/quality properties, the custom colors may be marketed to customers, and as described herein are referred to as “qualified” colors.

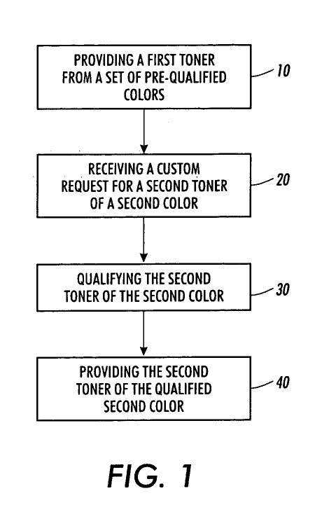

In an embodiment, the most frequently utilized or standard toner colors may be offered or sold to customers. These standard toner colors as illustrated in FIG. 1 may be referred to as Level I or Tier I toner color offerings and represent a set or list of pre-qualified toner colors from which a first toner color may be provided 10. An example of Level I color offerings may include a list of toner colors that are commonly utilized, for example, the list may include 9 toner colors. All Level I colors, representative of a set of colors from a desired color system, have been qualified to have a desired quality assurance level and may be referred to as the pre-qualified colors. All other colors in the color system that are not on the list of Tier I toner colors may then be referred to as Level II or Tier II toner colors. The Tier II toner color list represents a color list of toner colors that have not been qualified. The Tier I and Tier II toner colors may be located in a toner housing as described hereinbelow.

As discussed above, it may be impractical to qualify all the toner colors due to cost, time and the lack of resources while satisfying customer requests. Thus, according to an embodiment of the disclosure, when a customer requests a color that is not on the Tier I toner color list 20, the desired or requested color referred to as the Tier II toner color may then be qualified. Upon qualification of the Tier II toner color 30, the toner of the desired color may be provided to the customer 40.

In an another embodiment, the now-qualified Tier II color may be added to the Tier I pre-qualified color list. For example, the Tier II toner color may then be offered to a customer as a Tier I toner pre-qualified color to provide the customer with the flexibility to order the desired color at decreased lead times while obtaining the high quality of the color.

In another embodiment, a Tier II toner color may be ordered at a lower quality or performance level than that of the Tier I toner colors. In yet another embodiment, the Tier I toner color list may be modified to include Tier II toner colors or remove Tier I toner colors from the original Tier I color list. In another embodiment, each customer may have their own Tier I toner color list and Tier II toner color list customized for their use.

In use, a printing device may include more than one toner housing to receive the Tier I or Tier II toner colors. The toner housing may be a holding receptacle with at least one opening for receiving the toner and may also include an additional opening for dispensing the toner. The toner housing may include toners or toners with additional substances, such as a carrier and the like. The toner housing may be any desired shape.

The printing device may have a number of toner housings. For example, a printing device may include four individual toner housings. At least one, or possibly all four toner housings, may be dedicated for Tier I pre-qualified toner colors. The Tier II or qualified toner colors may then be received or provided in a dedicated compartment separate from the Tier I toner colors. For example, the compartment may be an additional fifth toner housing of the printing device for receiving the Tier II toner colors. In other embodiments, the compartment may be a designated area or portion of the four toner housings. In other embodiments, both Tier I and Tier II toner colors may be co-located and be supplied from the same toner housing unit.

In an embodiment, a printing device, such as a digital production printing press, for example, the iGen3® may include an additional toner housing. The additional toner housing may be used for a variety of different purposes, including printing a low cost black toner, printing a white toner for applications such as packaging, or printing a magnetic ink character recognition (MICR) toner for applications such as transaction printing applications including check printing which requires iron oxide or other material that permits certain information, such as bank line information on a check, to be read by electronic processing equipment. The printing device may include an additional toner housing to print customer specified custom colors.

Embodiments of the disclosure may provide numerous advantages. For example, the disclosure herein describes the ability to market all colors in a designated color system for dry xerography without immediately having to qualify or test all the colors within the color system. Additionally, lead times and reduced and consumers are provided with more flexibility in color selection for their printing needs.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of offering colors within a color system for use in xerography, comprising:
providing at least a first toner of a first color, wherein the first toner is selected from a set of pre-qualified colors;
receiving a customer request for a second toner of a second color, the second color being different than the first color;
qualifying the second color, and
providing a second toner of the qualified second color.

2. The method according to claim 1, wherein the qualified second color is received in a toner housing of a printing device.

3. The method according to claim 1, wherein the first toner and second toner are dry toners.

4. The method according to claim 1, further comprising adding the qualified second color to the set of pre-qualified colors.

5. This method according to claim 1, wherein the second color is provided based on consumer preference data.

6. The method according to claim 1, wherein qualifying the second color comprises performing color stability and color accuracy tests on the second toner.

7. The method according to claim 1, wherein the qualified second color has a color stability of up to about 3ΔE.

8. A method of fulfilling an order for toners for use in a color production printing device, comprising:
offering a first list of toner colors;
receiving a request for a toner of a desired color not included on the first list of toner colors;
performing color stability and color accuracy tests on the toner of the desired color; and
providing the toner of the desired color

9. The method according to claim 8, wherein the toners are dry toners.

10. The method according to claim 8, wherein the toner of the desired color is received in a toner housing of the color production printing device.

11. The method according to claim 8, wherein the toner of the desired color is located in a separate toner housing from the first list of toner colors.

12. The method according to claim 8, further comprising the step of adding the toner of the desired color to the first list of toner colors.

13. The method according to claim 8, wherein the toner colors from the first list of toner colors is a subset of colors in a color system.

14. The method according to claim 8, wherein colors on the first list of toner colors have a color stability of up to about 3ΔE.

15. A printing device for use in xerography, comprising:
at least one toner housing for receiving pre-qualified color toners; and
a compartment for receiving qualified toners.

16. The printing device according to claim 15, wherein the qualified toners are customer requested colors.

17. The printing device according to claim 15, wherein the qualified toners have a color stability of up to about 3ΔE.

18. The printing device according to claim 15, wherein the compartment is located separate from the at least one toner housing.

19. The printing device according to claim 15, wherein the compartment is located within the at least one toner housing.

20. The printing device according to claim 15, wherein compartment is at least one of a toner housing, a portion of the toner housing or a separate unit.
